(19) United States
(12) Patent Application Publication
(10) Pub. No.: US 2026/0126966 A1
(43) Pub. Date: May 7, 2026

(54) TECHNIQUES FOR MODIFYING PROGRAM CODE USING ARTIFICIAL INTELLIGENCE AGENTS

(71) Applicant: NVIDIA CORPORATION, Santa Clara, CA (US)

(72) Inventors: Sana DAMANI, Santa Clara, CA (US); Siva Kumar Sastry HARI, Sunnyvale, CA (US); Mark William STEPHENSON, Austin, TX (US)

(21) Appl. No.: 19/082,040

(22) Filed: Mar. 17, 2025

Related U.S. Application Data
(60) Provisional application No. 63/716,188, filed on Nov. 4, 2024.

(51) Int. Cl. G06F 8/35

(52) U.S. Cl. CPC G06F 8/35

(57) ABSTRACT

One embodiment of a method for modifying program code includes processing, using a first trained language model, program code to identify one or more modifications to the program code; processing, using a second trained language model, the program code and the one or more modifications to generate a plan for applying the one or more modifications; and processing, using a third trained language model, the program code and the plan to generate a modified program code.

### CROSS-REFERENCE TO RELATED APPLICATIONS

This application claims priority benefit of the United States Provisional Patent Application titled, “TECHNIQUES FOR OPTIMIZING CODE USING AGENTIC WORKFLOWS,” filed on Nov. 4, 2024, and having Ser. No. 63/716,188. The subject matter of this related application is hereby incorporated herein by reference.

### BACKGROUND

### Field of the Various Embodiments

The various embodiments relate generally to computer science, artificial intelligence, and machine learning and, more specifically, to techniques for modifying program code using artificial intelligence agents.

### Description of the Related Art

Program code can oftentimes be optimized to improve the efficiency, performance, and resource utilization of the program code. For example, program code could be optimized to reduce execution time, memory consumption, and/or power usage while maintaining or enhancing the functionality and readability of the program code. As another example, program code could be optimized to execute more efficiently on a particular type of processor, such as a graphics processing unit (GPU).

Program code is typically optimized via a largely manual process in which a programmer edits the program code to implement desired optimizations. For example, the programmer could assess reports generated by performance analysis tools that are applied to the program code, evaluate potential optimizations to different portions of the program code, and edit the program code to implement certain optimizations. The manual optimization of program code requires significant expertise and also is typically very labor intensive, time consuming, and error prone. Accordingly, more automated techniques have been developed to perform some optimizations without requiring program code to be edited manually.

One conventional approach for automatically optimizing program code uses compilers to make predefined modifications according to rules. Compilers are programs that translate high-level source code written in a user-readable programming language into low-level machine code that can be executed by a computer, which is also referred to as “compiling” the source code. During the compiling process, a compiler can use heuristics in the rules to identify portions of program code that can be optimized, search through different potential modifications to identify beneficial modifications to make, and then modify the portions of program code and/or adjust the compiler settings according to the identified modifications.

One drawback of compiler optimization, however, is that compiler optimization typically does not analyze the performance of program code to identify optimizations. Instead, compiler optimization relies on heuristics that may not always identify poorly performing code that needs to be optimized. Searching, by the compiler, through different potential modifications can also take a significant amount of time. In addition, compiler optimization can only make a limited set of predefined modifications to program code according to rules, without being able to make more complex modifications or modifications that are not included in the rules.

Another conventional approach for automatically optimizing program code uses a large language model (LLM) to understand the program code and apply optimizations to the program code. LLMs are a type of artificial intelligence (AI) model trained to understand and generate text, which can include program code. One drawback of optimizing program code using an LLM, however, is the LLM needs to be trained using a large amount of example optimizations as training data in order to be able to understand program code and apply similar optimizations. Such a large amount of example optimizations may not be readily available. Even if the large amount of example optimizations were available, training of the LLM using the example optimizations can take considerable time and consume a significant amount of energy. Currently, the LLMs that have been trained to optimize program code are largely limited to changing compiler settings and generating code that compilers are also able to generate. Like compilers, these LLMs are unable to make complex modifications to program code, such as modifications that require reasoning across broad sections of program code. In addition, the LLMs can hallucinate code that appears accurate but is actually incorrect code that cannot execute correctly.

As the foregoing illustrates, what is needed in the art are more effective techniques for optimizing program code.

### SUMMARY

One embodiment of the present disclosure sets forth a computer-implemented method for modifying program code. The method includes processing, using a first trained language model, program code to identify one or more modifications to the program code. The method further includes processing, using a second trained language model, the program code and the one or more modifications to generate a plan for applying the one or more modifications. In addition, the method includes processing, using a third trained language model, the program code and the plan to generate a modified program code.

One technical advantage of the disclosed techniques relative to the prior art is that, with the disclosed techniques, the performance of program code, as opposed to heuristics that do not consider such performance, is used to identify optimizations to the program code. The disclosed techniques enable optimizations to program code that are more complex than the optimizations that conventional compilers and LLMs are able to implement. The disclosed techniques also do not require a large amount of example optimizations to use as training data. In addition, the disclosed techniques test that the modified program code is capable of being executed correctly. The disclosed techniques result in modified program code that executes with fewer computing resources. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a more detailed illustration of the code transformer of FIG. 1, according to various embodiments;

FIG. 5 illustrates an exemplar transformation of an application by the code transformer of FIG. 1, according to various embodiments; and

FIG. 6 is a flow diagram of method steps for modifying code using various agents, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for modifying program code using artificial intelligent (AI) agents. Modifications to source code are also referred to herein as code “transformations.” Although described herein primarily with respect to code transformations as a reference example, in some embodiments, techniques disclosed herein can be applied to modify any suitable program code, such as intermediate representation (IR) code or low-level machine code. Given source code of an application as input, a code transformer application can use a workflow of AI agents to analyze runtime performance of the application, identify one or more optimizations and generate a plan for applying the optimization(s), modify the application according to the optimization(s), and test the modified application for correctness and performance. In some embodiments, the code transformer first processes the application using a performance analyzer agent that outputs one or more identified optimizations to perform on the application. Then, the code transformer inputs the identified optimization(s) and the application into an optimizer agent that generates an optimization plan including instructions for applying the identified optimization(s) to the application. The code transformer inputs the optimization plan and the application into a code transformer agent that modifies the application based on instructions in the optimization plan to generate an updated application. Then, the code transformer processes the updated application using a correctness tester agent that uses verification tools to check whether the updated application meets verification requirements. If the verification fails, then the correctness tester agent invokes exception handling tools to modify the updated application until a transformed application is generated that meets the verification requirements. After the exception handling, or if the verification by the correctness tester agent successfully verifies the updated application, the code transformer processes the transformed application using a performance tester agent that executes performance tests to determine a speedup of the transformed application over the input application. Thereafter, the code transformer outputs the speedup and analysis results from the performance testing via, for example, a user interface (UI).

The techniques for modifying program code of the present disclosure have many real-world applications. For example, these techniques can be used to modify program code that executes on a central processing unit (CPU) or a graphics processing unit (GPU).

The above examples are not in any way intended to be limiting. As persons skilled in the art will appreciate, as a general matter, the techniques for modifying program code that are described herein can be implemented in any application where improving the performance of program code is required or useful.

### System Overview

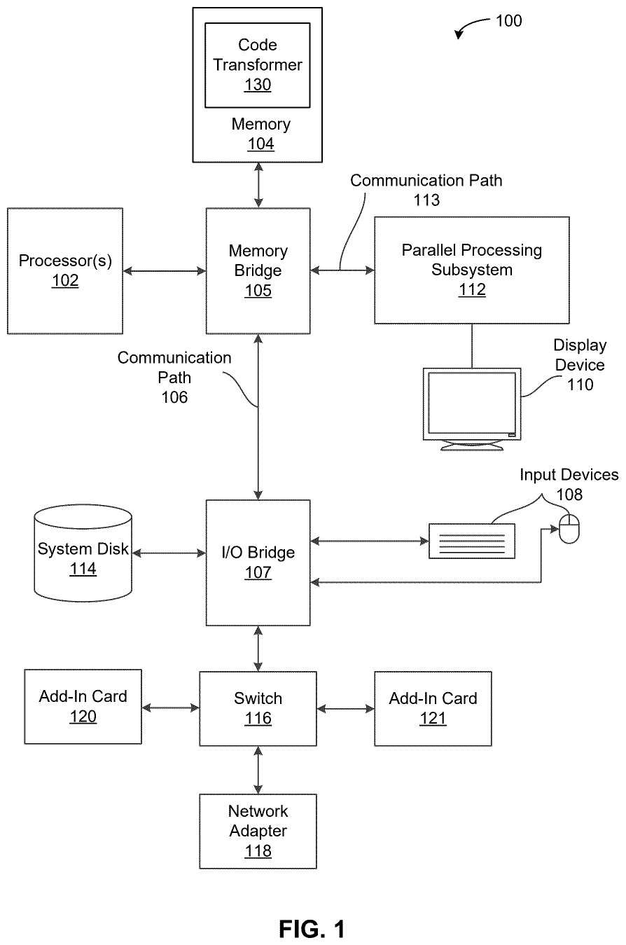

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, one or more processors 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to processor(s) 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

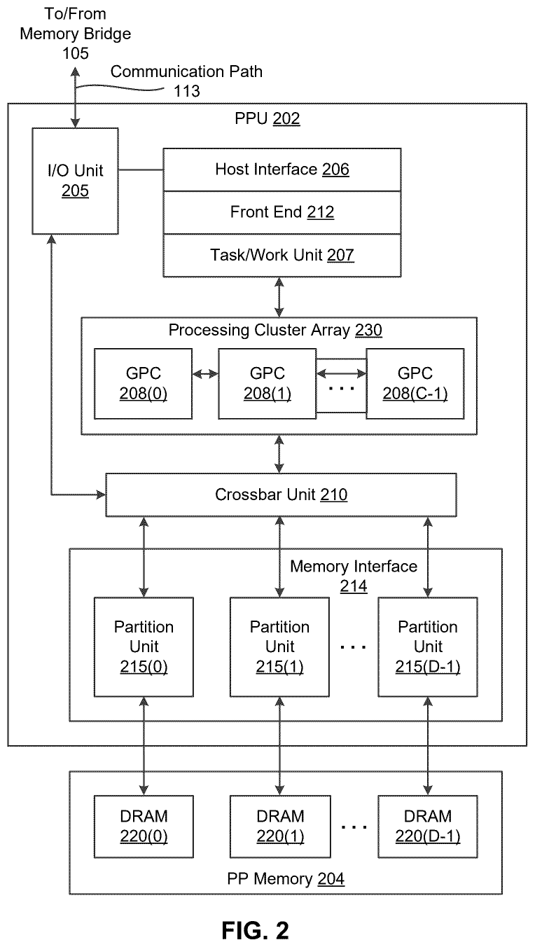

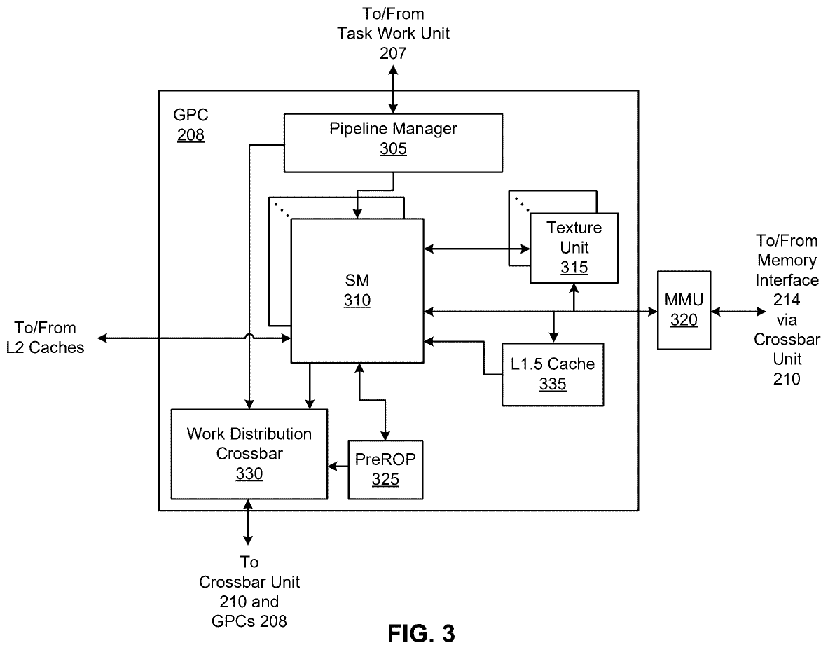

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

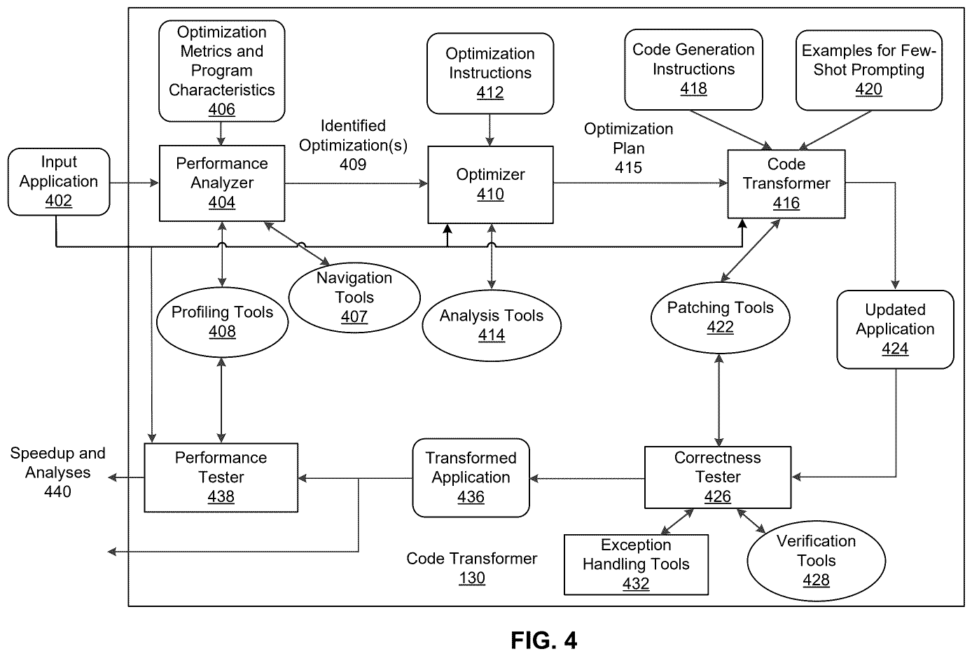

Illustratively, system memory 104 stores a code transformer 130. Code transformer 130 is an application configured to use a number of AI agents to analyze an input application, identify optimizations to apply, apply the optimizations to the input application to generate an updated application, verify the updated application, perform exception handling if the verification fails to generate a transformed application, and execute performance tests on the transformed application to determine a speedup over the input application, as discussed in greater detail below in conjunction with FIGS. 4-6. Although described herein primarily with respect to code transformer 130 as a reference example, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on chip (SoC).

In one embodiment, processor(s) 102 are the master processor(s) of computer system 100, controlling and coordinating operations of other system components. In one embodiment, processor(s) 102 issue commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to processor(s) 102 directly rather than through memory bridge 105, and other devices would communicate with system memory 104 via memory bridge 105 and processor(s) 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by processor(s) 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 118.

In some embodiments, processor(s) 102 are the master processor(s) of computer system 100, controlling and coordinating operations of other system components. In one embodiment, processor(s) 102 issue commands that control the operation of PPU 202. In some embodiments, processor(s) 102 write a stream of commands for PPU 202 to a data structure (not explicitly shown in either FIG. 1 or FIG. 2) that may be located in system memory 104, PP memory 204, or another storage location accessible to both processor(s) 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of processor(s) 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with processor(s) 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of code transformer 130As. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including processor(s) 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular code transformer 130A is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple code transformer 130As, where such code transformer 130As are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Modifying Program Code Using Artificial Intelligence Agents

FIG. 4 is a more detailed illustration of code transformer 130 of FIG. 1, according to various embodiments. As shown, code transformer 130 includes, without limitation, a performance analyzer agent 404, navigation tools 407, profiling tools 408, an optimizer agent 410, analysis tools 414, a code transformer agent 416, patch tools 422, a correctness tester agent 426, exception handling tools 432, verification tools 428, and a performance tester agent 438. In some embodiments, each of agents 404, 410, 416, 426, 438 can be a ReACT (Reasoning and Action) agent, and agents 404, 410, 416, 426, 438 collaborate to solve the complex task of program code optimization. Although shown as being included in code transformer 130 for illustrative purposes, in some embodiments, one or more of agents 404, 410, 416, 426, 438 and/or tools 407, 408, 414, 422, 428, 432 can be distinct from code transformer 130. For example, in some embodiments, one or more of agents 404, 410, 416, 426, 438 can run in a cloud computing environment and be accessed by code transformer 130 via an application programming interface (API).

In operation, when code transformer 130 receives input application 402 as input, code transformer 130 processes input application 402 using performance analyzer agent 404, which outputs one or more identified optimizations 409 to perform on input application 402. Code transformer 130 then inputs the identified optimization(s) 409 and input application 402 into optimizer agent 410, which outputs an optimization plan 415 that includes instructions for applying identified optimization(s) 409 to input application 402. Code transformer 130 inputs optimization plan 415 and input application 402 into code transformer agent 416, which modifies input application 402 based on the instructions in optimization plan 415 to generate an updated application 424. Then, code transformer 130 processes updated application 424 using correctness tester agent 426, which invokes verification tools 428 to check whether the updated application meets verification requirements. If the verification fails, then correctness tester agent 426 invokes exception handling tools 432 to modify updated application 424 until transformed application 436 is generated that meets the verification requirements. After the exception handling, or if the verification by correctness tester agent 426 successfully verifies updated application 424 (which can then be used as transformed application 436), code transformer 130 processes transformed application 436 using performance tester agent 438, which executes performance tests on transformed application 436 to determine a speedup over input application 402. Code transformer 130 then outputs the speedup and analyses 440 from the performance testing via, for example, a user interface (UI) (not shown). Although described herein primarily with respect to an input application as a reference example, techniques disclosed herein can be used to modify any program code, including program code that is not included in an application, in some embodiments.

Performance analyzer agent 404 includes a trained machine learning model that is used to analyze the execution profile of an application that is input into code transformer 130, shown as input application 402, and identify whether to perform one or more optimizations on the application. Any technically feasible trained machine learning model, such as a trained language model (e.g., a large language model (LLM)), can be included in performance analyzer agent 404 in some embodiments. Either the same trained machine learning model, or different trained machine learning models, can be used in agents 404, 410, 416, 426, 438 in some embodiments. Further, in some embodiments, the trained machine learning models that are included in agents 404, 410, 416, 426, 438 can either be pre-trained models or models that are trained and/or fine-tuned for the different tasks performed by agents 404, 410, 416, 426, 438. In some embodiments in which performance analyzer agent 404 includes a language model, code transformer 130 can prompt the language model with instructions for determining whether optimization(s) are useful based on profiling information and input application 402. The prompts described herein can, in some embodiments, be ReACT style prompts that provide available tools and descriptions thereof (e.g., explaining inputs and outputs of the tools, as well as what the tools do) to the language model(s) being used. In such cases, each agent 404, 410, 416, 426, 438 can know the tools the agent has access to and use ReACT style prompting to invoke any required tools. Although described herein primarily with respect to ReACT as a reference example, in some embodiments, any technically feasible tool calling agents can be used.

The instructions in a prompt for determining optimization(s) can include text describing information that the language model needs to search for in order to determine the optimization(s), enabling in-context learning by the language model. Illustratively, in some embodiments, the prompt can include instructions for analyzing performance metrics and program characteristics 406 of input application 402 that are determined by invoking profiling tools 408 and/or navigation tools 407. For example, the instructions can include a tree-of-thought for analyzing performance metrics and program characteristics 406. In some embodiments, performance analyzer agent 404 is optional, and performance analysis may not be performed if, for example, optimizer agent 410 directly generates an optimization plan for an input application without relying on performance analysis.

Performance analyzer agent 404 invokes profiling tools 408 and navigation tools 407 to obtain performance metrics and program characteristics 406 of input application 402. As described in greater detail below, one of the profiling tools 408 can be an annotation tool that modifies input application 402 by inserting comments that indicate profiling information at relevant locations within the source code of input application 402. Then, performance analyzer agent 404 prompts the language model (or other trained machine learning model) to analyze performance metrics and program characteristics 406 of input application 402 according to the tree of thought, described above. Alternatively, in some embodiments, the language model can itself invoke profiling tools 408 and navigation tools 407 to obtain and analyze performance information of input application 402. Given optimization metrics and program characteristics 406 and the instructions in the prompt, the language model outputs one or more optimizations, shown as identified optimization(s) 409, that should be applied to input application 402. In some embodiments, profiling tools 408 can include tools that measure aspects of the execution of input application 402, such as execution time, resource usage, execution frequency, stalls, memory bank conflicts, memory coalescing information, and/or the like. In some embodiments, profiling tools 408 can include value profiling tools that analyze and understand the characteristics and quality of program code. In some embodiments, profiling tools 408 also include an annotation tool that inserts comments indicating the profiling results at relevant locations (e.g., per-instruction profile information) within the source code of input application 402. Navigation tools 407 are tools that, for example, generate call graphs summarizing applications. Tools 407, 408, 409, 414, 422, 428, 432 can be implemented in any technically feasible manner in some embodiments. For example, in some embodiments, tools 408, 414, 422, 428, 432 can be implemented as scripts (e.g., Python scripts).

In some embodiments, performance analyzer agent 404 can output a yes or no, indicating whether a particular optimization should be applied to input application 402. In such cases, optimizer agent 410 can generate instructions for such an optimization when performance analyzer agent 404 outputs a yes, and code transformer agent 416 can perform the instructions to apply the optimization. In some embodiments, performance analyzer agent 404 can output one or more optimizations, selected from a list of potential optimizations, that should be applied to input application 402. In such cases, optimizer agent 410 can generate instructions for the identified optimization(s), and code transformer agent 416 can perform the instructions to apply the optimization(s).

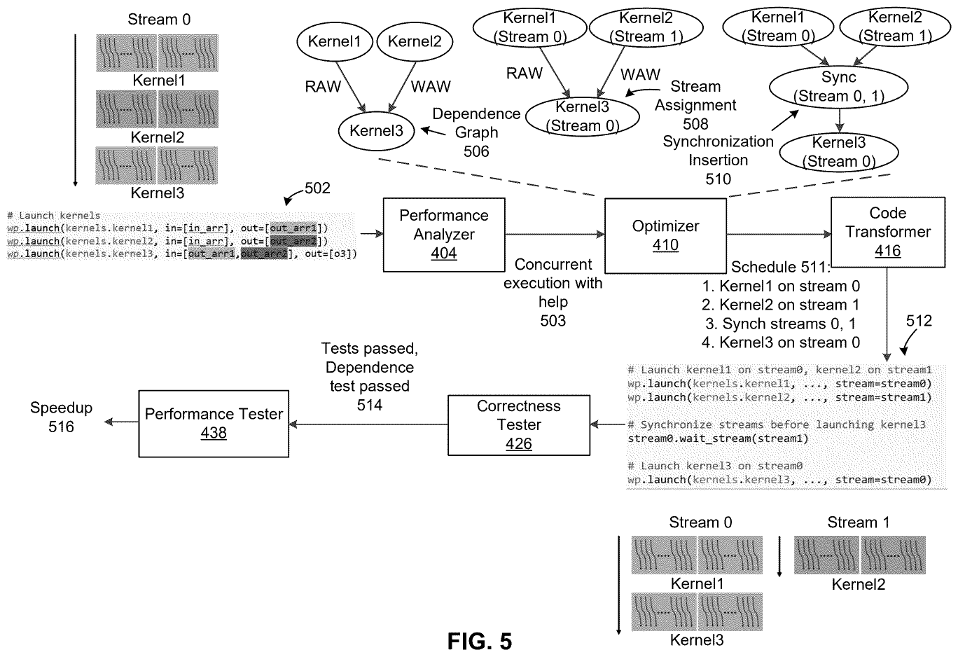

Optimizer agent 410 includes a trained machine learning model that is used to generate a plan that includes instructions for applying the identified optimization(s) 409 output by performance analyzer agent 404 to input application 402. Any technically feasible trained machine learning model, such as a trained language model (e.g., an LLM), can be included in optimizer agent 410 in some embodiments. As shown, in some embodiments in which optimizer agent 404 includes a language model, code transformer 130 can prompt the language model with optimization instructions 412 for generating an optimization plan 415 for input application 402. Any technically feasible optimization instructions 412 can be provided to the language model in some embodiments, and the particular optimization instructions 412 will generally depend on the identified optimization(s) 409. In some embodiments, when optimizer agent 410 is capable of generating optimization plans for multiple different optimizations that performance analyzer agent 404 can identify, optimizer agent 410 also retrieves optimization instructions 412 that are relevant to the identified optimization(s). In some embodiments, optimization instructions 412 can be provided for instruction following purposes as step-by-step instructions that the language model must follow to generate optimization plan 415. For example, in the case of a stream assignment optimization, described below in greater detail in conjunction with FIG. 5, the step-by-step instructions can include: (i) building a kernel dependence graph, (ii) assigning streams to kernels to maximize concurrency, (iii) inserting synchronization nodes to maintain dependencies, (iv) and creating schedule of kernels and synchronization nodes from the dependence graph.

Given the set of optimization instructions 412 (or other optimization algorithm), the language model generates optimization plan 415 for applying identified optimization(s) 409 to input application 402. Any suitable optimization plan 415 can be generated in some embodiments, and optimization plan 415 will generally depend on the optimization(s) to be performed. In some embodiments, optimization plan 415 can include instructions for code transformer agent 416 to implement the identified optimization(s). For example, in the case of stream assignment that is described in greater detail below in conjunction with FIG. 5, optimization plan 415 could include a schedule of kernels, stream assignments of the kernels, and synchronization nodes. In such a case, code transformer agent 416 could modify input application 402 to implement such a schedule. As another example, optimization plan 415 could include instructions in the form of a series of prompts for modifying input application 402, such as prompts for setting compiler options, generating code, and/or making code transformations, that are input into a language model included in code transformer agent 416. As a specific example, optimization plan 415 could include instructions for passing one or more compiler options, such as register counts and/or compiler knobs. As another example, in some embodiments, optimization plan 415 could include instructions for inserting one or more compiler hints, such as cache hints and/or pragmas, into input application 402. As a further example, optimization plan 415 could include more complex instructions, such as multi-step reasoning instructions for modifying the code of input application 402. For example, the complex instructions could include instructions for performing kernel-level transformations, such as intra-kernel transformations (e.g., loop transformations, use of shared memory, and/or algorithmic transformations). As yet another example, the complex instructions could include instructions for applying application-level optimizations, such as transforming kernel or host site code, replacing manually written kernels with library calls, transformations that require visibility across kernels, inter-kernel transformations (e.g., kernel fusion and/or stream assignment), and/or the like.

In some embodiments, optimizer agent 410 can invoke one or more analysis tools 414 to analyze input application 402 when generating optimization plan 415. Any technically feasible analysis tools 414 can be used in some embodiments, and the specific analysis tools 414 that are used will generally depend on the optimization(s). For example, analysis tools 414 could include an occupancy calculator for register target selection. As another example, analysis tools 414 could include a tool that identifies frequently used data that should be cached. As a further example, analysis tools 414 could include navigation tools. As yet another example, analysis tools 414 could include tools to analyze dependence graphs in order to, e.g., check that the dependence graphs are correct.

Code transformer agent 416 takes as input optimization plan 415 and input application 402, and code transformer agent 416 transforms input application 402 with the aid of patch tools 422, optionally with a user in the loop. In some embodiments, code transformer agent 416 includes a trained machine learning model that is used to modify input application 402 according to optimization plan 415 to generate an updated application, shown as updated application 424. Any technically feasible trained machine learning model, such as a trained language model (e.g., an LLM), can be included in code transformer agent 416 in some embodiments. When a trained language model is used, code transformer agent 416 can leverage the code generation capabilities of the language model to modify program code of input application 402 with the aid of patch tools 422. Whether code needs to be generated will generally depend on the optimization(s) and the instructions in optimization plan 415. For example, if optimization plan 415 includes instructions for passing one or more compiler options, then the language model could simply invoke patch tools 422 that set environment variable(s) to set the compiler options. As another example, if optimization plan 415 includes instructions for inserting one or more compiler hints, then the language model could invoke patch tools 422 to insert the compiler hint(s) at certain lines of code. As a further example, if optimization plan 415 includes more complex instructions, such as replacing a kernel, then the language model could be prompted to generate code and then invoke patch tools 422 to insert the generated code into input application 402 and/or replace existing code of input application 402 with the generated code. Optionally, a user can be in the loop to edit the program code as well and/or change the automated modifications made by code transformer agent 416. When optimization plan 415 includes a series of prompts, as described above, code transformer 130 inputs the prompts into code transformer agent 416, which applies successive transformations using the language model to modify input application 402. For example, the series of prompts could include instructions to insert code at a particular line number, replace a kernel with a transformed kernel, and/or the like, and the language model can modify input application 402 according to such prompts to generate updated application 424.

Illustratively, code transformer agent 416 also receives as input code generation instructions 418 and examples for few-shot prompting 420. The examples for few-shot prompting 420 can be included in one or more prompts to the language model for purposes of in-context learning, so that the language model can perform instruction following in-context learning and modify input application 402 in a similar manner as the examples. In some embodiments, the prompt(s) can also include explanations of the reasoning behind how the examples were created. For example, in the case of a kernel fusion optimization, the examples can include simple kernels and fused kernels. As another example, in the case of a loop unrolling optimization, the examples can include simple loops being unrolled. In some embodiments, when code transformer agent 416 is capable of making multiple different optimizations, code transformer agent 416 can also retrieve examples that are relevant to the optimization(s) being performed. In some embodiments, code generating instructions 418 can include chain-of-thought instructions for performing particular code modifications.

As described, code transformer agent 416 can invoke patch tools 422 to perform some or all of the modifications to input application 402. Any technically feasible patch tools 422 can be utilized to apply changes or updates to specific portions of input application 402 in some embodiments. For example, in some embodiments, patch tools 422 can include tools for inserting, deleting, and/or replacing code in one or more files of input application 402. As a specific example, the language model could be prompted to generate code, and patch tools 422 could be invoked to insert the generated code at a specific line within input application 402 or replace a specific portion of input application 402, according to instructions in optimization plan 415. Use of patch tools 422 can help reduce errors and limit the output context when a language model is used. In some embodiments, as an additional safeguard, the source code of input application 402 can include programmer-defined read-only code regions that are delimited by, for example, comments in order prevent code transformer agent 416 from making changes to portions of input application 402 that should remain unmodified for correctness reasons. In some embodiments, patch tools 422 can also check to make sure requested modifications to input application 402 are not within the read-only code portions and return an error if there is a violation.

Although code transformer agent 416 for generating updated application 424 is shown as a single agent for illustrative purposes, in some embodiments, different code transformer agents can be used to perform different modifications to input application 402 to generate updated application 424. In such cases, each code transformer agent can be specialized for performing a different optimization, such as by prompting language models differently or using language models that are fine-tuned for different optimizations.

Correctness tester agent 426 includes a trained machine learning model that is used to determine whether updated application 424 meets one or more verification requirements. Any technically feasible trained machine learning model, such as a trained language model (e.g., an LLM), can be included in correctness tester agent 426 in some embodiments. Illustratively, correctness tester agent 426 invokes verification tools 428 to check the correctness of updated application 424. Any technically feasible verification tools 428 can be used in some embodiments. For example, in some embodiments, verification tools 428 can first check that updated application 424 can compile (with compiler options, if any) and, assuming the compilation is successful, run the compiled updated application 424 and execute runtime tests in order to, e.g., check that outputs of updated application 424 match expected outputs. In some embodiments, verification tools 428 can include compilers, unit tests, code sanitizers to check for race conditions or memory safety violations, formal verification tools that check whether the properties of updated application 424 meet certain specifications, and/or the like.

If the verification of updated application 424 by correctness tester agent 426 fails, then correctness tester agent 426 can use exception handling tools 432 to generate another updated application, shown as transformed application 436, that meets the verification requirements. Any technically feasible exception handling tools 432, potentially with a user in the loop, can be used in some embodiments. For example, in some embodiments, exception handling tools 432 can revert updated application 424 back to input application 402, which can be processed again (e.g., using different hyperparameters, different trained machine learning models, and/or the like) to generate another updated application that is verified by correctness tester agent 426. In such cases, after the reversion, a user can optionally choose to start the workflow again with the same or modified specifications. As another example, in some embodiments, exception handling tools 432 can include debugging tools that identify and fix errors in updated application 424 to generate transformed application 436.

Performance tester agent 438 includes a trained machine learning model that is used to execute one or more performance tests on transformed application 436 to determine a speedup over input application 402. Any technically feasible trained machine learning model, such as a trained language model (e.g., an LLM), can be included in performance tester agent 438 in some embodiments. Illustratively, in some embodiments, performance tester agent 438 invokes profiling tools 408 to analyze the performance of transformed application 436, which can also be compared against the performance of input application 402 to determine performance improvements. As described, profiling tools 408 can measure aspects of the execution of transformed application 436 (and input application 402), such as execution time, resource usage, execution frequency, stalls, memory bank conflicts, memory coalescing information, the characteristics and quality of transformed application 436, and/or the like. The performance analysis results generated by performance tester agent 438 can then be output as a speedup and analyses 440 of transformed application 436. For example, in some embodiments, code transformer 130 can output speedup and analyses 440 via a UI (not shown). In some embodiments in which performance tester agent 436 includes a language model, the language model can also summarize changes in the metrics output by profiling tools 408 and provide an explanation for any speedup or slowdown of transformed application 436 over input application 402.

FIG. 5 illustrates an exemplar transformation of an application by code transformer 130 of FIG. 1, according to various embodiments. As shown, in the case of a stream assignment optimization for an input application 502 to be executed on a GPU that includes multiple SMs, code transformer 130 can generate transformed code as follows. Although a stream assignment example is shown for illustrative purposes, any suitable optimizations can be performed in some embodiments, such as the insertion of compiler options and/or compiler hints, kernel-level transformations, and/or application-level transformations, described above in conjunction with FIG. 4.

Given input application 502, code transformer 130 first processes input application 502 using performance analyzer agent 404. Performance analyzer agent 404 invokes profiling tools 408 to generate a profile (e.g., a Nsight Systems® profile) of input application 502. Then, performance analyzer agent 404 inspects the profile to determine whether input application 502 launches multiple kernels on a stream and whether such kernels observe low SM occupancy. If the kernels observe low SM occupancy, then performance analyzer agent 404 outputs that stream assignment optimization should be performed, shown as concurrent execution with help 503.

Code transformer 130 processes input application 402 and the identified optimization(s) 409 using optimizer agent 410 to generate an optimization plan. Optimizer agent 410 analyzes input application 402 in the context of the stream assignment optimization and generates the optimization plan, shown as a schedule 511 of kernels, stream assignments of the kernels, and synchronization nodes, that instructs code transformer agent 416 on how to modify the code of input application 502. Illustratively, to generate schedule 511, optimizer agent 410 performs multiple sub-steps: (i) building a kernel dependence graph 506, (ii) assigning 508 streams to kernels to maximize concurrency, (iii) inserting synchronization nodes 510 to maintain dependencies, (iv) and creating schedule 511 of kernels and synchronization nodes from the dependence graph. In some embodiments, the multiple sub-steps can be included in step-by-step instructions that a language model included in code transformer agent 416 must follow to generate an optimization plan, enabling instruction following in-context learning by the language model.

Then, code transformer 130 processes input application 402 and schedule 511 using code transformer agent 416 to generate an updated application 512. Code transformer agent 416 takes as input the optimization plan, shown as schedule 511, as well as input application 502. Based on schedule 511, code transformer agent 416 transforms input application 502 with the aid of patch tools 422, optionally with a user in the loop. In the stream optimization example, kernel body and verification code can be marked as read-only in the source code of input application 402, and code transformer agent 416 will not modify those portions of code. Illustratively, code transformer agent 416 has modified input application 502 according to schedule 511 to generate updated application 512, which includes kernel1 and kernel3 on stream 0 and kernel2 on stream 1, as opposed to all kernels being launched on the same (default) stream and executing sequentially, shown as kernel1, kernel2, and kernel3 being executed on stream 0 in input application 502. By assigning independent kernels to different streams with appropriate inter-stream synchronization for correct operation, concurrency and improved GPU resource usage can be achieved for improved performance.

Code transformer 130 processes updated application 512 using correctness tester agent 426 to determine whether updated application 512 meets one or more verification requirements. Correctness tester agent 426 invokes verification tools 428 and reports the outcome of verification—pass or fail. For the stream optimization example, correctness tester agent 426 can test updated application 512 using unit tests and with a verification tool that compares a new dependence graph of updated application 512 to the original dependence graph of input application 502 to ensure that no dependencies were violated during the transformation step. If the verification fails, correctness tester agent 426 can invoke exception handling tools 432 to fix any errors in updated application 512.

Illustratively, when the unit tests and dependence test pass 514, code transformer 130 processes updated application 512, which is a transformed application, using performance tester agent 438 to determine a speedup 516 of updated application 512 over input application 502. As described, in some embodiments, performance tester agent 438 can invoke profiling tools 408 to determine the speedup of updated application 512 over input application 502. In some embodiments, performance tester agent 438 can include a language model that summarizes the changes in performance metrics and provides an explanation for the speedup or slowdown, if any.

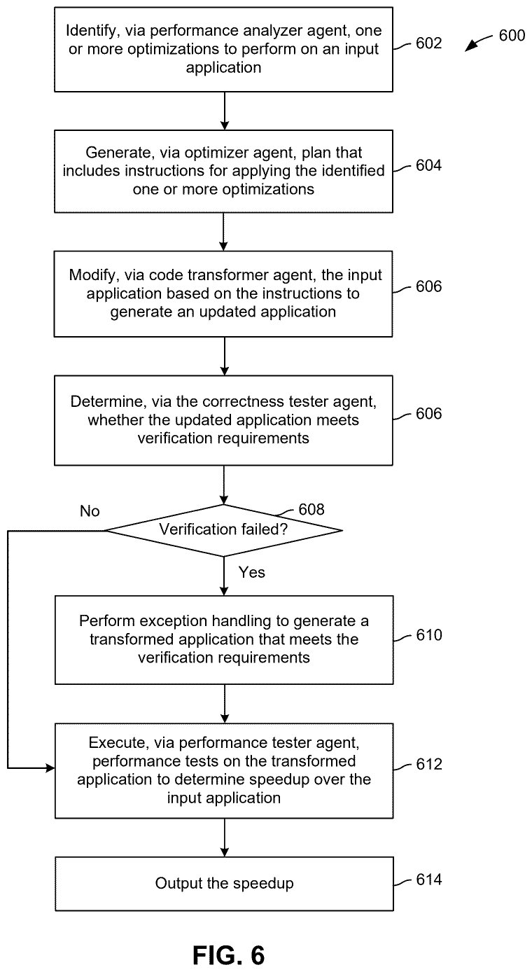

FIG. 6 is a flow diagram of method steps for modifying code using various agents, according to various embodiments. Although the method steps are described in conjunction with FIGS. 1-5, persons skilled in the art will understand that any system configured to perform the method steps, in any order, falls within the scope of the present disclosure.

As shown, a method 600 begins at step 602, where code transformer 130 identifies, via performance analyzer agent 404, one or more optimizations to perform on an input application. As described, performance analyzer agent 404 includes a trained machine learning model, such as a language model, that is used to identify whether to perform optimizations on the input application. In some embodiments in which performance analyzer agent 404 includes a language model, code transformer 130 can prompt the language model with instructions, such as a tree of thought, for determining whether an optimization is useful based on profiling information and the input application. Performance analyzer agent 404 invokes profiling tools 408 and navigation tools 407, described above in conjunction with FIG. 4, to obtain performance metrics and program characteristics of the input application. Then, performance analyzer agent 404 prompts the language model to analyze the performance metrics and program characteristics according to the instructions, described above, to identify one or more optimizations that should be applied to the input application. In some embodiments, performance analyzer agent 404 can output a yes or no, indicating whether a particular optimization should be applied to the input application. In some other embodiments, performance analyzer agent 404 can output one or more optimizations, selected from a list of potential optimizations, that should be applied to the input application.

At step 604, code transformer 130 generates, via optimizer agent 410, a plan that includes instructions for applying the identified optimization(s). As described, optimizer agent 410 includes a trained machine learning model, such as a language model, that is used to generate a plan that includes instructions for applying optimization(s) identified by performance analyzer agent 404 to the input application. In some embodiments in which optimizer agent 404 includes a language model, code transformer 130 can prompt the language model with optimization instructions, such as step-by-step instructions that must be followed, for generating the optimization plan. Any suitable optimization plan can be generated in some embodiments, such as an optimization plan that includes instructions for one or more modifications to implement, a series of prompts for modifying the input application that can be input into code transformer agent 416, and/or the like. In some embodiments, optimizer agent 410 can also invoke analysis tools 414, such as occupancy calculators, navigation tools, etc., to analyze input application 402 when generating optimization plan 415.

At step 606, code transformer 130 modifies, via code transformer agent 416, the input application based on the instructions to generate an updated application. As described, code transformer agent 416 includes a trained machine learning model, such as a language model, that is used to modify the input application according to the optimization plan output by optimization agent 410 to generate an updated application. In some embodiments, code transformer agent 416 also receives as input, or retrieves based on the optimization(s) being performed, code generation instructions and examples for few-shot prompting, which can be included in prompts to a language model for purposes of in-context learning. In addition, code transformer agent 416 can use the language model to generate code and/or invoke patch tools 422, which can include code insertion, deletion, and/or replacement tools, to perform some or all of the modifications to the input application. Use of patch tools 422 can help reduce errors and limit the output context when a language model is used. In some embodiments, code transformer agent 416 can include multiple code transformer agents that are specialized for performing different optimizations, such as by prompting language models differently or using language models that are fine-tuned for different optimizations. In some embodiments, as an additional safeguard, source code of the input application can include programmer-defined read-only code regions that are delimited by, for example, comments. In such cases, code transformer agent 416 will not make changes to the delimited portions of the input application. For example, patch tools 422 could check to make sure requested modifications to the input application are not within the read-only code portions and return an error if there is a violation.

At step 608, code transformer 130 determines, via correctness tester agent 426, whether the updated application meets verification requirements. As described, correctness tester agent 426 includes a trained machine learning model, such as a LLM, that is used to determine whether the updated application meets one or more verification requirements. In some embodiments, correctness tester agent 426 invokes verification tools 428 to first check that the updated application can compile (with compiler options, if any) and, assuming the compilation is successful, run the compiled updated application and execute runtime tests in order to, e.g., check that outputs of the updated application match expected outputs. In some embodiments, verification tools 428 can include compilers, unit tests, code sanitizers to check for race conditions or memory safety violations, formal verification tools that check whether properties of the updated application meet certain specifications, and/or the like.

At step 610, if the verification at step 608 fails, then method 600 continues to step 612, where code transformer 130 performs exception handling to generate a transformed application. As described, any technically feasible exception handling tools 432 can be used in some embodiments to perform exception handling. For example, in some embodiments, exception handling tools 432 can revert an updated application back to an input application, which can be processed again (e.g., using different hyperparameters, different trained machine learning models, and/or the like) to generate another updated application that is verified by correctness tester agent 426. In such cases, after the reversion, a user can optionally choose to start the workflow again with the same or modified specifications. As another example, in some embodiments, exception handling tools 432 can include tools that identify and fix errors in the updated application to generate a transformed application. After the exception handling at step 612, method 600 returns to step 608, where code transformer 130 determines, via correctness tester agent 426, whether the updated application meets verification requirements. Accordingly, code of the application can be iteratively updated until the updated application meets verification requirements.

When code transformer 130 determines at step 610 that the verification succeeded (in which case the updated application generated at step 606 can be used as a transformed application), method 600 continues to step 614, where code transformer 130 executes, via performance tester agent 438, performance tests on the transformed application to determine a speedup over the input application. As described, performance tester agent 438 includes a trained machine learning model, such as a large language model, that is used to execute one or more performance tests on the transformed application to determine a speedup over the input application. In some embodiments, performance tester agent 438 invokes profiling tools 408 to analyze the performance of the transformed application, such as execution time, resource usage, execution frequency, stalls, memory bank conflicts, memory coalescing information, and/or the like, the characteristics and quality of the transformed application, and/or the like. The performance of the transformed application can also be compared against the performance of the input application to determine performance improvements, i.e., a speedup.

At step 616, code transformer 130 outputs the speedup determined at step 614. The speedup can be output in any technically feasible manner in some embodiments. For example, in some embodiments, code transformer 130 can output the speedup via a UI. In some embodiments, performance tester agent 438 can include a language model that summarizes the changes in performance metrics of the transformed application over the input application and provides an explanation for any speedup or slowdown.

At step 618, code transformer 130 determines whether to continue transforming the application. After applying one or more transformations, code transformer 130 can decide to apply additional transformation(s). If code transformer 130 determines to continue transforming the application, then method 600 returns to step 602, where code transformer 130 identifies, via performance analyzer agent 404, one or more addition optimizations to perform on the application. On the other hand, if code transformer 130 determines not to continue transforming the application, then method 600 ends.

In sum, techniques are disclosed for modifying program code using AI agents. Given source code of an application as input, a code transformer application can use a workflow of AI agents to analyze runtime performance of the application, identify one or more optimizations and generate a plan for applying the optimization(s), modify the application according to the optimization(s), and test the modified application for correctness and performance. In some embodiments, the code transformer first processes the application using a performance analyzer agent that outputs one or more identified optimizations to perform on the application. Then, the code transformer inputs the identified optimization(s) and the application into an optimizer agent that generates an optimization plan including instructions for applying the identified optimization(s) to the application. The code transformer inputs the optimization plan and the application into a code transformer agent that modifies the application based on instructions in the optimization plan to generate an updated application. Then, the code transformer processes the updated application using a correctness tester agent that uses verification tools to check whether the updated application meets verification requirements. If the verification fails, then the correctness tester agent invokes exception handling tools to modify the updated application until a transformed application is generated that meets the verification requirements. After the exception handling, or if the verification by the correctness tester agent successfully verifies the updated application, the code transformer processes the transformed application using a performance tester agent that executes performance tests to determine a speedup of the transformed application over the input application. Thereafter, the code transformer outputs the speedup and analysis results from the performance testing via, for example, a UI.

One technical advantage of the disclosed techniques relative to the prior art is that, with the disclosed techniques, the performance of program code, as opposed to heuristics that do not consider such performance, is used to identify optimizations to the program code. The disclosed techniques enable optimizations to program code that are more complex than the optimizations that conventional compilers and LLMs are able to implement. The disclosed techniques also do not require a large amount of example optimizations to use as training data. In addition, the disclosed techniques test that the modified program code is capable of being executed correctly. The disclosed techniques result in modified program code that executes with fewer computing resources. These technical advantages provide one or more technological improvements over prior art approaches.

1. In some embodiments, a computer-implemented method for modifying program code comprises processing, using a first trained language model, program code to identify one or more modifications to the program code, processing, using a second trained language model, the program code and the one or more modifications to generate a plan for applying the one or more modifications, and processing, using a third trained language model, the program code and the plan to generate modified program code.

2. The computer-implemented method of clause 1, wherein processing the program code to identify the one or more modifications comprises processing, using one or more profiling tools, the program code to generate one or more profiling results, inserting, into the program code, one or more comments that indicate the one or more profiling results to generate annotated program code, and processing, using the first trained language model, the annotated program code to identify the one or more modifications.

3. The computer-implemented method of clauses 1 or 2, wherein processing the program code and the one or more modifications to generate the plan comprises inputting a set of instructions for generating the plan into the second trained language model.

4. The computer-implemented method of any of clauses 1-3, wherein the plan includes at least one of one or more prompts or one or more instructions for implementing the one or more modifications.

5. The computer-implemented method of any of clauses 1-4, wherein processing the program code and the plan to generate the modified program code comprises inputting at least one of one or more instructions for generating code or one or more examples into the third trained language model.

6. The computer-implemented method of any of clauses 1-5, further comprising verifying whether the modified program code satisfies one or more requirements.

7. The computer-implemented method of any of clauses 1-6, further comprising, in response to not verifying that the modified program code satisfies the one or more requirements, invoking one or more exception handling tools to generate another modified program code.

8. The computer-implemented method of any of clauses 1-7, further comprising determining one or more performance metrics of the modified program code relative to the program code, and outputting the one or more performance metrics via a user interface.

9. The computer-implemented method of any of clauses 1-8, wherein the one or more modifications include at least one of passing one or more compiler options, inserting one or more compiler hints, or one or more intra-kernel or inter-kernel transformations.

10.The computer-implemented method of any of clauses 1-9, wherein the first trained language model, the second trained language model, and the third trained language model are a same trained language model.

11.In some embodiments, one or more non-transitory computer-readable media store instructions that, when executed by at least one processor, cause the at least one processor to perform steps comprising processing, using a first trained language model, program code to identify one or more modifications to the program code, processing, using a second trained language model, the program code and the one or more modifications to generate a plan for applying the one or more modifications, and processing, using a third trained language model, the program code and the plan to generate modified program code.

12.The one or more non-transitory computer-readable media of clause 11, wherein processing the program code to identify the one or more modifications comprises processing, using one or more profiling tools, the program code to generate one or more profiling results, inserting, into the program code, one or more comments that indicate the one or more profiling results to generate annotated program code, and processing, using the first trained language model, the annotated program code to identify the one or more modifications.

13.The one or more non-transitory computer-readable media of clauses 11 or 12, wherein processing the program code and the one or more modifications to generate the plan comprises inputting a set of instructions for generating the plan into the second trained language model.

14.The one or more non-transitory computer-readable media of any of clauses 11-13, wherein processing the program code and the plan to generate the modified program code comprises inputting at least one of one or more instructions for generating code or one or more examples into the third trained language model.

15.The one or more non-transitory computer-readable media of any of clauses 11-14, wherein the instructions, when executed by the at least one processor, further cause the at least one processor to perform the step of verifying whether the modified program code satisfies one or more requirements.

16.The one or more non-transitory computer-readable media of any of clauses 11-15, wherein verifying whether the modified program code satisfies the one or more requirements comprises compiling the modified program code to generate compiled code, and executing one or more runtime tests during execution of the compiled code.

17.The one or more non-transitory computer-readable media of any of clauses 11-16, wherein the instructions, when executed by the at least one processor, further cause the at least one processor to perform the steps of determining one or more performance metrics of the modified program code relative to the program code, and outputting the one or more performance metrics via a user interface.

18.The one or more non-transitory computer-readable media of any of clauses 11-17, wherein processing the program code and the plan to generate the modified program code comprises invoking one or more patch tools that change the program code.

19.The one or more non-transitory computer-readable media of any of clauses 11-18, wherein the first trained language model, the second trained language model, and the third trained language model are a same trained large language model.

20.In some embodiments, a system comprises one or more memories storing instructions, and one or more processors that are coupled to the one or more memories and, when executing the instructions, are configured to perform the steps of processing, using a first trained language model, program code to identify one or more modifications to the program code, processing, using a second trained language model, the program code and the one or more modifications to generate a plan for applying the one or more modifications, and processing, using a third trained language model, the program code and the plan to generate a modified program code.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for modifying program code, the method comprising:
processing, using a first trained language model, program code to identify one or more modifications to the program code;
processing, using a second trained language model, the program code and the one or more modifications to generate a plan for applying the one or more modifications; and
processing, using a third trained language model, the program code and the plan to generate modified program code.

2. The computer-implemented method of claim 1, wherein processing the program code to identify the one or more modifications comprises:
processing, using one or more profiling tools, the program code to generate one or more profiling results;
inserting, into the program code, one or more comments that indicate the one or more profiling results to generate annotated program code; and
processing, using the first trained language model, the annotated program code to identify the one or more modifications.

3. The computer-implemented method of claim 1, wherein processing the program code and the one or more modifications to generate the plan comprises inputting a set of instructions for generating the plan into the second trained language model.

4. The computer-implemented method of claim 1, wherein the plan includes at least one of one or more prompts or one or more instructions for implementing the one or more modifications.

5. The computer-implemented method of claim 1, wherein processing the program code and the plan to generate the modified program code comprises inputting at least one of one or more instructions for generating code or one or more examples into the third trained language model.

6. The computer-implemented method of claim 1, further comprising verifying whether the modified program code satisfies one or more requirements.

7. The computer-implemented method of claim 6, further comprising, in response to not verifying that the modified program code satisfies the one or more requirements, invoking one or more exception handling tools to generate another modified program code.

8. The computer-implemented method of claim 1, further comprising:
determining one or more performance metrics of the modified program code relative to the program code; and
outputting the one or more performance metrics via a user interface.

9. The computer-implemented method of claim 1, wherein the one or more modifications include at least one of passing one or more compiler options, inserting one or more compiler hints, or one or more intra-kernel or inter-kernel transformations.

10. The computer-implemented method of claim 1, wherein the first trained language model, the second trained language model, and the third trained language model are a same trained language model.

11. One or more non-transitory computer-readable media storing instructions that, when executed by at least one processor, cause the at least one processor to perform steps comprising:
processing, using a first trained language model, program code to identify one or more modifications to the program code;
processing, using a second trained language model, the program code and the one or more modifications to generate a plan for applying the one or more modifications; and
processing, using a third trained language model, the program code and the plan to generate modified program code.

12. The one or more non-transitory computer-readable media of claim 11, wherein processing the program code to identify the one or more modifications comprises:
processing, using one or more profiling tools, the program code to generate one or more profiling results;
inserting, into the program code, one or more comments that indicate the one or more profiling results to generate annotated program code; and
processing, using the first trained language model, the annotated program code to identify the one or more modifications.

13. The one or more non-transitory computer-readable media of claim 11, wherein processing the program code and the one or more modifications to generate the plan comprises inputting a set of instructions for generating the plan into the second trained language model.

14. The one or more non-transitory computer-readable media of claim 11, wherein processing the program code and the plan to generate the modified program code comprises inputting at least one of one or more instructions for generating code or one or more examples into the third trained language model.

15. The one or more non-transitory computer-readable media of claim 11, wherein the instructions, when executed by the at least one processor, further cause the at least one processor to perform the step of verifying whether the modified program code satisfies one or more requirements.

16. The one or more non-transitory computer-readable media of claim 15, wherein verifying whether the modified program code satisfies the one or more requirements comprises:
compiling the modified program code to generate compiled code; and
executing one or more runtime tests during execution of the compiled code.

17. The one or more non-transitory computer-readable media of claim 11, wherein the instructions, when executed by the at least one processor, further cause the at least one processor to perform the steps of:
determining one or more performance metrics of the modified program code relative to the program code; and
outputting the one or more performance metrics via a user interface.

18. The one or more non-transitory computer-readable media of claim 11, wherein processing the program code and the plan to generate the modified program code comprises invoking one or more patch tools that change the program code.

19. The one or more non-transitory computer-readable media of claim 11, wherein the first trained language model, the second trained language model, and the third trained language model are a same trained large language model.

20. A system, comprising:
one or more memories storing instructions; and
one or more processors that are coupled to the one or more memories and, when executing the instructions, are configured to perform the steps of:
processing, using a first trained language model, program code to identify one or more modifications to the program code,
processing, using a second trained language model, the program code and the one or more modifications to generate a plan for applying the one or more modifications, and
processing, using a third trained language model, the program code and the plan to generate a modified program code.
